(19) United States
(12) Patent Application Publication
(10) Pub. No.: US 2017/0291444 A1
(43) Pub. Date: Oct. 12, 2017

(54) BOOKBINDING SYSTEM

(71) Applicant: Gradco Japan Ltd., Shinagawa-ku, Tokyo (JP)

(72) Inventor: Kazushige MASUNARI, Shinagawa-ku, Tokyo (JP)

(21) Appl. No.: 15/510,358

(22) PCT Filed: Apr. 28, 2016
(86) PCT No.: PCT/JP2016/063346

§ 371 Date: Mar. 10, 2017

(30) Foreign Application Priority Data
Apr. 30, 2015 (JP) 2015-092612
Jan. 12, 2016 (JP) 2016-003757

(51) Int. Cl. B42C 19/02; B65H 37/04; B42C 19/08

(52) U.S. Cl. CPC B42C 19/02; B42C 19/08; B65H 37/04

(57) ABSTRACT

Problem: To make it possible to bind a large amount of booklets in a short period of time by using a book binding apparatus efficiently.

Solution: A book binding apparatus 10 includes a book binding part 11 which binds a booklet, a book binding control part 12 which controls the book binding part 11 based on book binding information, and a book binding apparatus side book binding information setting part 13 which sets the book binding information. A paper feeding apparatus 20 includes a feeding part 21 which feeds a recorded paper one sheet by one sheet, a feeding control part 22 which controls the feeding part 21 based on the book binding information, and a paper feeding apparatus side book binding information setting part 23 which sets the book binding information. The book binding apparatus 10 and the paper feeding apparatus 20 can be communicated with each other. Based on the book binding information set in the book binding apparatus side book binding information setting part 13 or the paper feeding apparatus side book binding information setting part 23, the recorded paper is fed from the paper feeding apparatus 20 to the book binding apparatus 10 one sheet by one sheet and the recorded papers are bundled and bound by the book binding apparatus 10.

### TECHNICAL FIELD

The present invention relates to a book binding system which binds and bundles a plurality of recorded papers into a booklet having a paper bundle.

### BACKGROUND ART

Conventionally, various kinds of a book binding system which receives a paper such as a copying paper fed from an image forming apparatus such as a copying machine, a printer and a facsimile and binds a booklet by gluing a paper bundle formed of a plurality of papers with a cover and thereafter cuts an edge surface other than a joining surface of the booklet by using a cutter are proposed. Patent Literature 1 discloses a technique as one example of such a book binding system.

### CITATION LIST

### Patent Literature

Patent Literature 1: JP 2005-104063 A

### SUMMARY OF INVENTION

### Technical Problem

In this way, a device which receives a paper fed from an image forming apparatus and binds a plurality of recorded papers into a booklet having a paper bundle consecutively is known, however with a configuration in which paper bundles printed by an image forming apparatus as another device are mounted to a paper feeding apparatus and the papers is fed from the paper feeding apparatus to a book binding apparatus in order to bind a book, a large amount of booklets can be bound from the papers printed by the image forming apparatus as another device in a short period of time by using the book binding apparatus efficiently.

An object of the present invention is, in consideration of the fact described above, to provide a book binding system capable of binding a large amount of books in a short period of time by using a book binding apparatus efficiently.

### Solution to Problem

In order to solve the problem and achieve the object, the present invention is constituted as follows.

The invention according to claim 1 is a book binding system including: a book binding apparatus which bundles and binds a plurality of recorded papers into a booklet having a paper bundle; and a paper feeding apparatus which feeds the recorded paper to the book binding apparatus one sheet by one sheet, wherein the book binding apparatus includes a book binding part which binds the booklet, a bookbinding control part which controls the book binding part based on book binding information, and a book binding apparatus side book binding information setting part which sets the book binding information, the paper feeding apparatus includes a feeding part which feeds the recorded paper one sheet by one sheet, a feeding control part which controls the feeding part based on the book binding information, and a paper feeding apparatus side book binding information setting part which sets the book binding information, the book binding apparatus and the paper feeding apparatus are communicable with each other, and based on the book binding information set in the book binding apparatus side book binding information setting part or the paper feeding apparatus side book binding information setting part, the recorded paper is fed from the paper feeding apparatus to the book binding apparatus one sheet by one sheet and the recorded papers are bundled and bound by the book binding apparatus.

The invention according to claim 2 is the book binding system according to claim 1, wherein the book binding information includes the number of the binding booklets and the number of the papers bundled in book binding.

The invention according to claim 3 is the book binding system according to claim 1 or 2, wherein the paper feeding apparatus includes a reading unit which reads the book binding information adhered to the recorded paper, the book binding information acquired by the reading unit is transmitted to the book binding apparatus, the recorded paper is fed from the paper feeding apparatus to the book binding apparatus one sheet by one sheet, and the recorded papers are bound into the paper bundle by the book binding apparatus.

The invention according to claim 4 is the book binding system according to any one of claims 1 to 3, wherein the paper feeding apparatus includes a recording state recognizing unit which recognizes a recording state of the recorded paper, and in a case in which the recording state recognized by the recording state recognizing unit is defective, the feeding by the paper feeding apparatus is stopped and the book binding by the book binding apparatus is stopped.

The invention according to claim 5 is the book binding system according to any one of claims 1 to 3, wherein the paper feeding apparatus includes a paper reversing part which reverses the paper to be fed between a front surface and a rear surface, and the paper feeding apparatus controls the paper reversing part based on the book binding information and feeds the paper to be fed to the bookbinding apparatus one sheet by one sheet without reversing the paper so that the papers are bound into the paper bundle by the book binding apparatus, or feeds the paper to be fed to the bookbinding apparatus one sheet by one sheet after reversing the paper so that the papers are bound into the paper bundle by the book binding apparatus.

The invention according to claim 6 is the book binding system according to any one of claims 1 to 5, wherein the feeding part includes: a loading base which loads the paper; and a delivery part which feeds the paper loaded on the loading base to the book binding apparatus one sheet by one sheet.

The invention according to claim 7 is the book binding system according to claim 6, wherein the delivery part includes a sucking fan which feeds the loaded paper while sucking one sheet by one sheet.

### Advantageous Effects of Invention

According to the configuration described above, the present invention achieves advantageous effects described below.

In the invention described in claim 1, the book binding apparatus and the paper feeding apparatus can be communicated with each other, and based on the book binding information set in the book binding apparatus side book binding information setting part or the paper feeding apparatus side book binding information setting part, the recorded paper is fed from the paper feeding apparatus to the book binding apparatus one sheet by one sheet and the recorded papers are bundled and bound into the paper bundle by the book binding apparatus, and thereby a large amount of booklets can be bound from the paper printed by the printing system or the like as another device by using the book binding apparatus in a short period of time.

In the invention described in claim 2, the book binding information includes the number of the binding booklets and the number of the papers bundled in book binding, and thereby predetermined booklets can be bound by communicating the book binding apparatus and the paper feeding apparatus with each other.

In the invention described in claim 3, the reading unit mounted to the paper feeding apparatus reads the book binding information adhered to the recorded paper, and the book binding information is transmitted to the book binding apparatus, and the recorded paper is fed from the paper feeding apparatus to the bookbinding apparatus one sheet by one sheet, and the recorded papers are bound into the paper bundle by the book binding apparatus, and thereby the book binding operation can be operated automatically.

In the invention described in claim 4, in a case in which the recording state recognized by the recording state recognizing unit is defective, the feeding by the paper feeding apparatus is stopped and the book binding by the book binding apparatus is stopped, and thereby automatic stop of the system becomes possible.

In the invention described in claim 5, the paper reversing part is controlled based on the book binding information, and a paper to be fed is fed to the book binding apparatus one sheet by one sheet without reversing the paper so that the papers are bound into the paper bundle by the book binding apparatus, or the paper to be fed is fed to the book binding apparatus one sheet by one sheet after reversing the paper so that the papers are bound into the paper bundle by the book binding apparatus. Accordingly, the book binding can be carried out after feeding the papers based on the book binding information from a side of the book binding apparatus.

In the invention described in claim 6, the feeding part includes a loading base on which the paper is loaded and a delivery part which feeds the paper loaded on the loading base to the book binding apparatus one sheet by one sheet, and thereby the paper loaded on the loading base can be sucked and fed one sheet by one sheet precisely.

In the invention described in claim 7, the delivery part includes a sucking fan which feeds the loaded paper while sucking one sheet by one sheet, and thereby the loaded paper can be fed while sucking one sheet by one sheet with a simple structure of the sucking fan.

### BRIEF DESCRIPTION OF DRAWINGS

FIG. 1 is a diagram illustrating a schematic configuration of a book binding system.

FIG. 2 is a diagram illustrating a small size paper feeding apparatus and a book binding apparatus connected with each other.

FIG. 3 is a diagram illustrating a large size paper feeding apparatus and the book binding apparatus connected with each other.

FIG. 4 is a diagram illustrating a configuration of the small size paper feeding apparatus.

FIGS. 5(a) and 5(b) are diagrams illustrating operation of the small size paper feeding apparatus.

FIGS. 6(a) and 6(b) are diagrams illustrating a configuration of a small size paper feeding apparatus according to another embodiment.

FIG. 7 is a diagram illustrating a configuration of a paper feeding apparatus provided with a reversing mechanism.

FIG. 8 is a block diagram illustrating a configuration of the book binding system.

FIGS. 9(a) and 9(b) are diagrams illustrating automatic book binding.

FIG. 10 is a diagram illustrating a print checking function.

FIGS. 11(a) and 11(b) are diagrams illustrating a paper reversing function.

FIGS. 12(a) and 12(b) are diagrams illustrating a paper reversing function.

### DESCRIPTION OF EMBODIMENTS

Hereinafter, book binding systems according to embodiments of the present invention are described. The embodiments of the present invention merely show the best mode of the present invention, and therefore the present invention is not limited to the embodiments.

### Schematic Configuration of Book Binding System

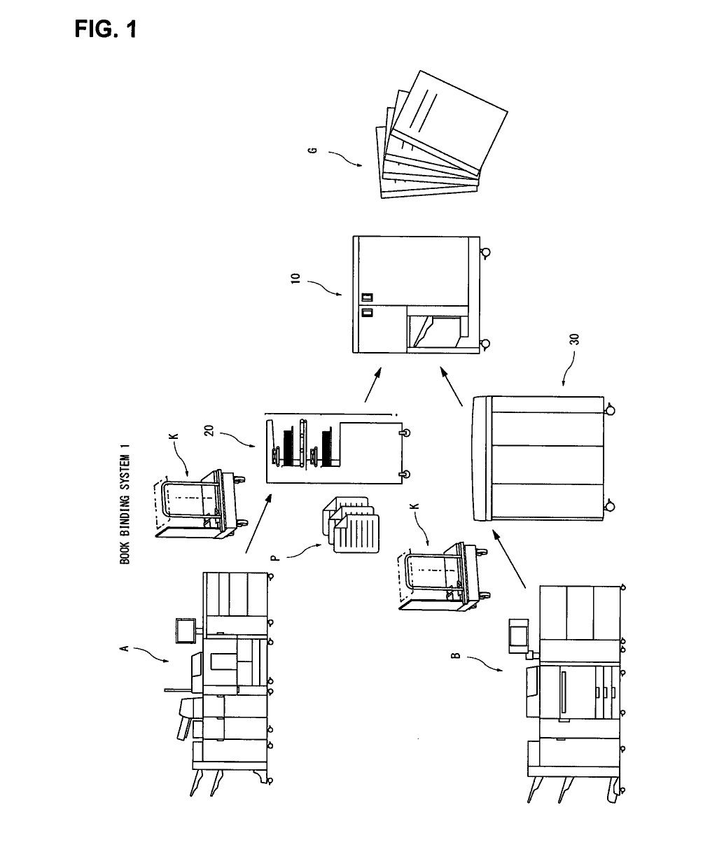

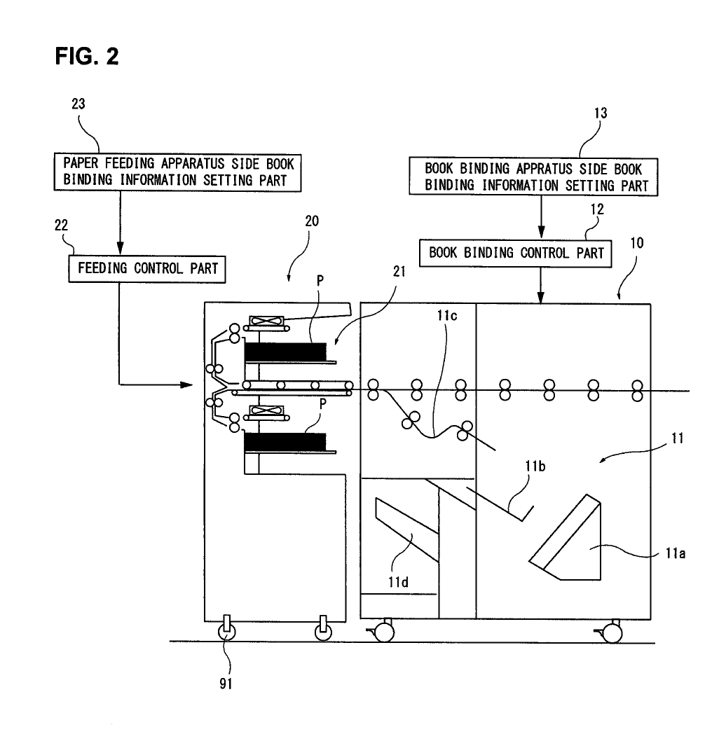

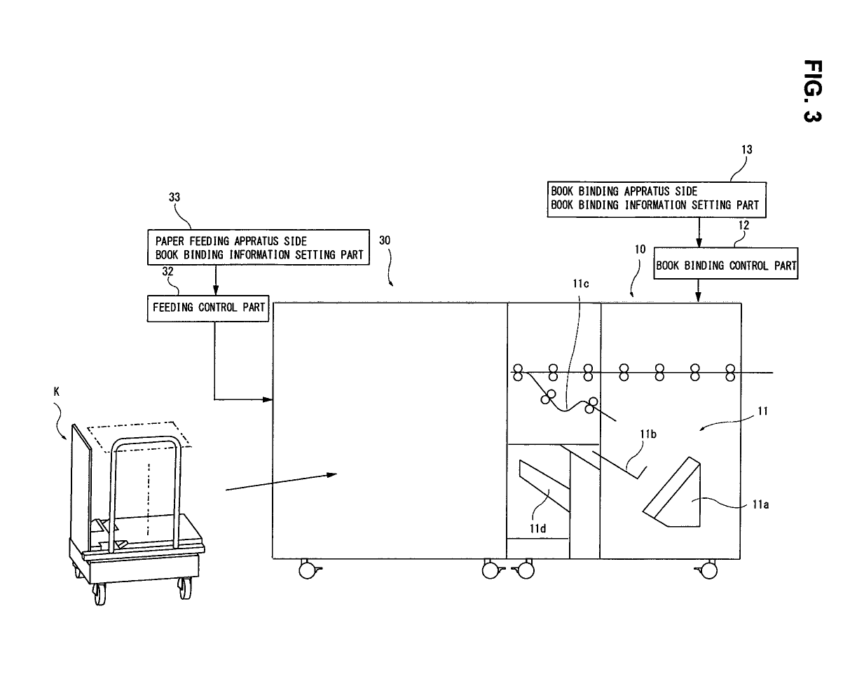

FIG. 1 is a diagram illustrating a schematic configuration of a bookbinding system. FIG. 2 is a diagram illustrating a small size paper feeding apparatus and a book binding apparatus connected with each other. FIG. 3 is a diagram illustrating a large size paper feeding apparatus and the bookbinding apparatus connected with each other.

As shown in FIG. 1, a book binding system 1 according to the present embodiment is provided by connecting a small size paper feeding apparatus 20 or a large size paper feeding apparatus 30 to a book binding apparatus 10. A paper P printed by a printing system A or a printing system B as other device is carried to the small size paper feeding apparatus 20 or the large size paper feeding apparatus 30 by a cart tray K, and then the paper P is fed to the book binding apparatus 30 from the small size paper feeding apparatus 20 or the large size paper feeding apparatus 30 one sheet by one sheet. Further, the recorded paper P may be carried to the small size paper feeding apparatus 20 by using the cart tray K, or alternatively by a hand of a user.

In the book binding apparatus 10, a plurality of the recorded papers are bundled and bound into a booklet G having a paper bundle. In book binding, for example, the paper bundle is bonded with a cover by glue or an adhesive tape, however the paper bundle may be bonded without using the cover.

### Configuration of Book Binding Apparatus

As shown in FIG. 2 and FIG. 3, the book binding apparatus 10 is provided with a book binding part 11 which binds the booklet, a book binding control part 12 which controls the book binding part 11 based on book binding information, and a book binding apparatus side book binding information setting part 13 which sets the book binding information.

The book binding part 11 is provided with a binder 11a for binding the papers, a compiler 11b which makes the loaded paper stay in standby before binding operation, a paper transferring path 11c which transfers the paper to the compiler 11b or the like, a stacker 11d which discharges the bound papers after the binding operation to the outside and loads the papers, and the like. The book binding part 11 is formed to bind a plurality of the recorded papers into the booklet having the paper bundle.

### Configuration of Small Size Paper Feeding Apparatus

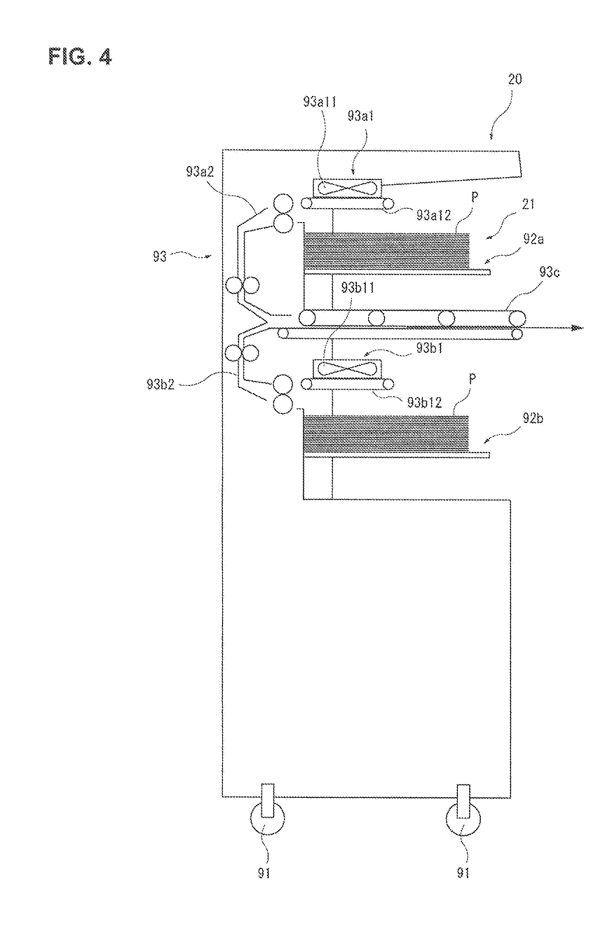

As shown in FIG. 2 and FIG. 4, the small size paper feeding apparatus 20 is provided with a caster 91 at a lower part thereof, and therefore the small size paper feeding apparatus 20 is formed to be movable freely. The paper feeding apparatus 20 is provided with a feeding part 21 which feeds the recorded paper P one sheet by one sheet, a feeding control part 22 which controls the feeding part 21 based on the book binding information, and a paper feeding apparatus side book binding information setting part 23 which sets the book binding information.

The feeding part 21 is provided with upper and lower loading bases 92a, 92b arranged in two stages of an upper side and a lower side, and a delivery part 93 which feeds the paper loaded on the loading bases 92a, 92b one sheet by one sheet . The delivery part 93 is provided with an upper side sucking part 93a1, an upper side feeding path 93a2, a lower side sucking part 93b1, a lower side feeding path 93b2, and a collection delivery part 93c. The upper side sucking part 93a1 is formed to suck the paper loaded on the loading base 92a by sucking air to feed the paper to the upper side feeding path 93a2. Similarly, the lower side sucking part 93b1 is formed to suck the paper loaded on the loading base 92b by sucking air to feed the paper to the lower side feeding path 93b2.

The upper side sucking part 93a1 and the lower side sucking part 93b1 are provided with sucking fans 93a11, 93b11 which feed the paper loaded on the loading bases 92a, 92b by sucking one sheet by one sheet, and delivery belts 93a12, 93b12, respectively. The upper side sucking part 93a1 and the lower side sucking part 93b1 are formed to suck the paper by the sucking fans 93a11, 93b11 and make the delivery belts 93a12, 93b12 hold the paper and feed the paper by means of driving of the delivery belts 93a12, 93b12, respectively. Accordingly, the papers loaded on the loading bases 92a, 92b can be precisely fed while sucking one sheet by one sheet with simple structures, respectively. The upper side feeding path 93a2 and the lower side feeding path 93b2 are provided with feeding rollers, feeding guides and the like, respectively. Similarly, the collection delivery part 93c is provided with a feeding roller, a feeding guide and the like.

In the present embodiment, the loading bases 92a, 92b are arranged in the two stages of the upper side and the lower side, however a plurality of the loading bases may be arranged above the collection delivery part 93c, or alternatively the plurality of the loading bases may be arranged below the collection delivery part 93c. Further, in the delivery part 93, a configuration in which the upper side sucking part 93a1 and the lower side sucking part 93b1 sucks the paper P is adopted, however a configuration in which a delivery roller mechanism feeds the paper on the loading base one sheet by one sheet may be adopted.

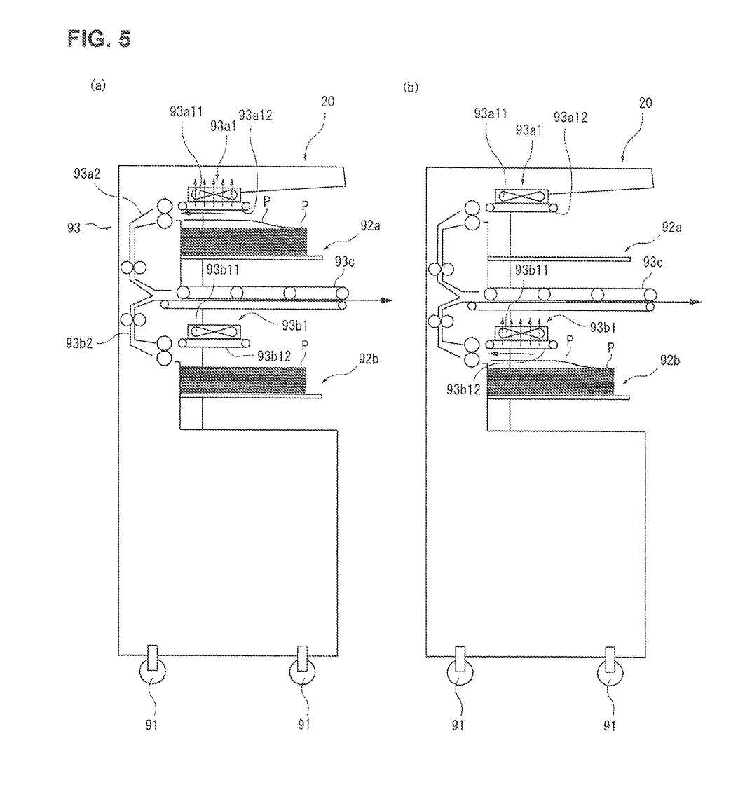

As shown in FIG. 5 (a) , in the small size paper feeding apparatus 20, the upper side sucking part 93a1 is driven to feed the paper loaded on the loading part 92a one sheet by one sheet to the upper side feeding path 93a2, and the paper is fed by the upper side feeding path 93a2 to the book binding apparatus via the collection delivery part 93c. As shown in FIG. 5 (b) , when feeding of the paper loaded on the loading base 92a is finished, the lower side sucking part 93b1 is driven to feed the paper loaded on the loading base 92b one sheet by one sheet to the lower side feeding path 93b2, and the paper is fed by the lower side feeding path 93b2 to the book binding apparatus via the collection delivery part 93c.

### Configuration of Small Size Paper Feeding Apparatus According to Second Embodiment

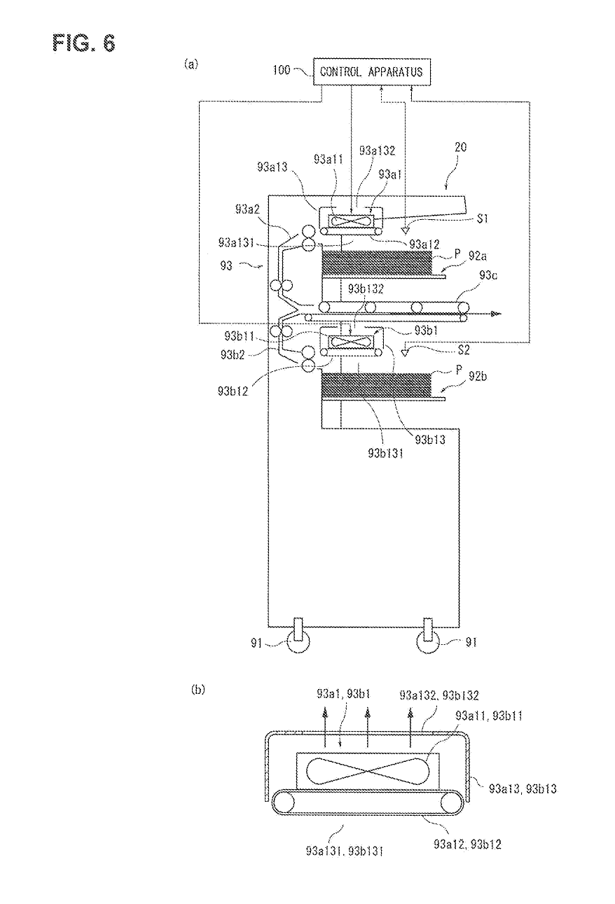

A small size paper feeding apparatus 20 according to the present embodiment is formed as shown in FIGS. 6(a) and 6(b), and the same numeral reference is assigned to the same configuration as the first embodiment, and the description thereof is therefore omitted. An upper side sucking part 93a1 and a lower side sucking part 93b 1 according to the present embodiment are provided with sucking fans 93a11, 93b11, delivery belts 93a12, 93b12, and covers 93a13, 93b13, respectively. The cover 93a13 covers the sucking fan 93a11 and the delivery belt 93a12, and the cover 93a13 is provided with a lower opening part 93a131 and an upper opening part 93a132. It is constructed that air is sucked from the lower opening part 93a131 at a lower side by means of driving of the sucking fan 93a11 and the air is transferred to the upper opening part 93a132 at an upper side, and a paper loaded on a loading base 92a is held by the delivery belt 93a12 and the paper is fed by means of driving of the delivery belt 93a12.

The cover 93b13 covers the sucking fan 93b11 and the delivery belt 93b12, and the cover 93b13 is provided with a lower opening part 93b131 and an upper opening part 93b132. It is constructed that air is sucked from the lower opening part 93b131 at a lower side by means of driving of the sucking fan 93b11 and the air is transferred to the upper opening part 93b132 at an upper side, and a paper loaded on a loading base 92b is held by the delivery belt 93b12 and the paper is fed by means of driving of the delivery belt 93b12.

The small size paper feeding apparatus 20 according to the present embodiment is provided with paper detection sensors S1, S2 and the small size paper feeding apparatus 20 is formed such that a control apparatus 100 controls the upper side sucking part 93a1 and the lower side sucking part 93b1 based on paper detection information acquired from the paper detection sensors S1, S2. For example, when the paper loaded on the loading base 92a is fed by the driving of the upper side sucking part 93a1 one sheet by one sheet and the paper detection sensor S1 detects end of the feeding of the paper, the control apparatus 100 stops the driving of the upper side sucking part 93a1 based on the detection information and drives the lower side sucking part 93b1. When the paper loaded on the loading base 92b is fed by the driving of the lower side sucking part 93b1 one sheet by one sheet and the paper detection sensor S2 detects end of the feeding of the paper, the control apparatus 100 stops the driving of the lower side sucking part 93b1.

### Configuration of Large Size Paper Feeding Apparatus

As shown in FIG. 3, a large size paper feeding apparatus 30 is provided with a feeding control part 32 which controls a feeding part based on the book binding information, and a paper feeding apparatus side book binding information setting part 33 which sets the book binding information. Further, similar to the small size paper feeding apparatus 20, the large size paper feeding apparatus 30 is provided with a feeding part, a paper reversing part, a recording state recognizing unit, a page reading unit and the like and constructed similarly, and therefore the description thereof is omitted.

In the large size paper feeding apparatus 30, the paper P printed by the printing system A or the printing system B as other device is carried to the large size paper feeding apparatus 30 by the cart tray K and the paper P is set in the large size paper feeding apparatus 30 such that the paper P is loaded in the cart tray K, and the paper P loaded in the cart tray K is fed to the book binding apparatus 10 one sheet by one sheet. Further, the paper P may be fed to the book binding apparatus 10 after the paper P is transferred and loaded to the feeding part from the cart tray K.

Configuration of Paper Feeding Apparatus provided with Reversing Mechanism

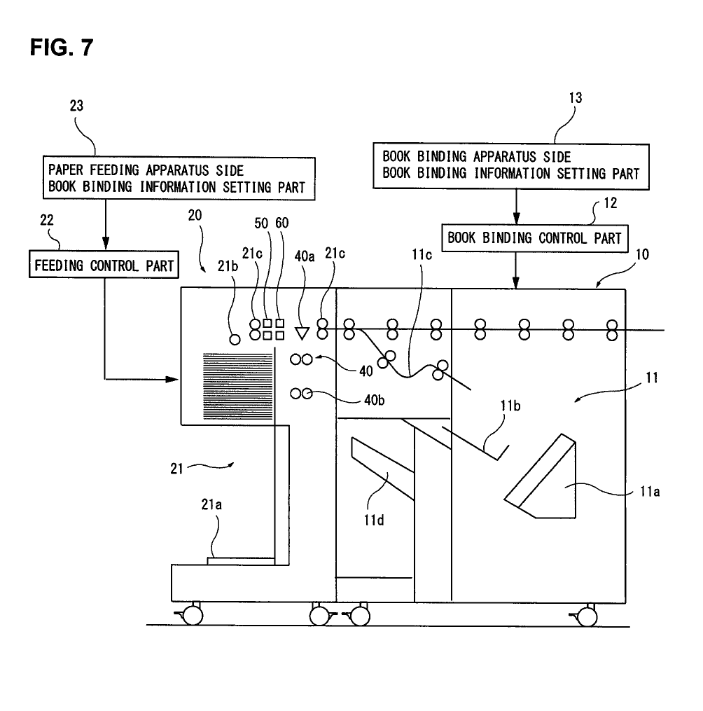

As shown in FIG. 7, the paper feeding apparatus 20 according to the present embodiment is provided with the feeding part 21 which feeds the recorded paper one sheet by one sheet, a paper reversing part 40 which reverses the paper to be fed between a front surface and a rear surface of the paper, a recording state recognizing unit 50 which recognizes a recording state of the recorded paper, a page reading unit 60 which reads page numbers of the front surface and the back surface of the paper to be fed, the feeding control part 22 which controls the feeding part 21 based on the book binding information, and the paper feeding apparatus side book binding information setting part 23 which sets the book binding information.

The feeding part 21 is provided with an elevating base 21a for transferring the loaded paper to a feeding position, a delivery roller 21b for transferring the paper, the feeding roller 21c and the like. The feeding part 21 feeds the recorded paper to the book binding apparatus 10 one sheet by one sheet. The paper reversing part 40 is provided with a paper reversing blade 40a, and a reversing roller 40b. The feeding control part 22 controls the paper reversing part 40 to feed the paper to the book binding apparatus 10 one sheet by one sheet by the feeding roller 21c without activating the reversing blade 40a when the paper to be fed is not reversed. When the paper to be fed is reversed, the reversing blade 40a is activated and the paper is transferred to the reversing roller 40b and reversed, and then the paper reversed by the reversing blade 40a is fed by the feeding roller 21c to the book binding apparatus 10 one sheet by one sheet.

### Configuration of Book Binding System

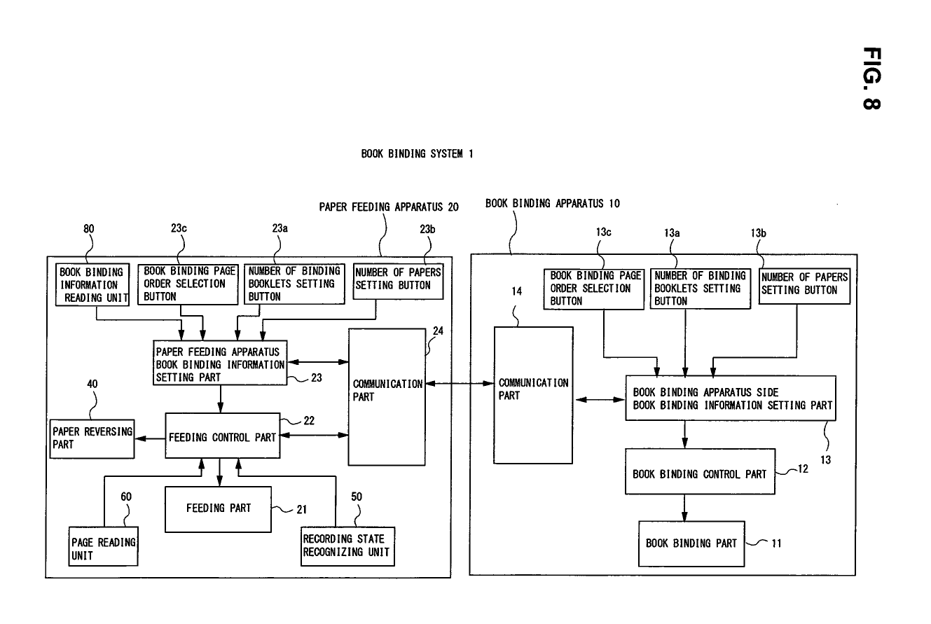

FIG. 8 is a block diagram illustrating a configuration of the book binding system. The book binding system 1 is provided with the book binding apparatus 10 which bundles and binds a plurality of the recorded papers into a booklet having a paper bundle, the small size paper feeding apparatus 20 or the large size paper feeding apparatus 30 which feeds the recorded paper to the book binding apparatus 10 one sheet by one sheet. The small size paper feeding apparatus 20 and the large size paper feeding apparatus 30 have the same structures to each other except the numbers of the loaded papers, and therefore hereinafter it is described as the paper feeding apparatus 20.

The book binding apparatus 10 and the paper feeding apparatus 20 are provided with communication parts 14, 24, respectively, and information can be mutually communicated between the book binding apparatus 10 and the paper feeding apparatus 20 via the communication parts 14, 24. The recorded paper is fed from the paper feeding apparatus 20 to the book binding apparatus 10 one sheet by one sheet based on the book binding information set in the book binding apparatus side book binding information setting part 13 or the paper feeding apparatus side book binding information setting part 23, and the recorded papers are bundled and bound into the paper bundle by the book binding apparatus 10.

The book binding information includes the number of the binding booklets and the number of the papers bundled in the book binding, and the information is mutually communicated between the book binding apparatus 10 and the paper feeding apparatus 20, and thereby a predetermined number of the booklets can be bound. For example, the number of the binding booklets and the number of the papers bundled in the book binding are set in the book binding apparatus side book binding information setting part 13 by using the number of the binding booklets setting button 13a and the number of the papers setting button 13b, and this book binding information is send to the paper feeding apparatus 20. In the paper feeding apparatus 20, the feeding part 21 is controlled by the feeding control part 22 based on the book binding information to be sent, and the recorded paper is fed by the feeding part 21 one sheet by one sheet. In the book binding apparatus 10, the book binding part 11 is controlled by the book binding control part 12 based on the book binding information set by the book binding apparatus side book binding information setting part 13 to bind the booklet. Further, for example, the number of the binding booklets and the number of the papers bundled in the book binding are set in the paper feeding apparatus side book binding information setting part 23 by using the number of the binding booklets setting button 23a and the number of the papers setting button 23b, and this book binding information is sent to the book binding apparatus 10. In the paper feeding apparatus 20, the feeding part 21 is controlled by the feeding control part 22 based on the book binding information, and the recorded paper is fed by the feeding part 21 one sheet by one sheet. In the book binding apparatus 10, the book binding part 11 is controlled by the book binding control part 12 based on the book binding information sent by the paper feeding apparatus side book binding information setting part 23 to bind the booklet.

In this way, in the book binding apparatus 10 and the paper feeding apparatus 20, the information can be mutually communicated, and based on the book binding information set in the book binding apparatus side book binding information setting part 13 or the paper feeding apparatus side book binding information setting part 23, the recorded paper is fed from the paper feeding apparatus 20 to the book binding apparatus 10 one sheet by one sheet and the recorded papers are bundled and bound into the paper bundle by the book binding apparatus 10. Accordingly, a large amount of the booklets can be bound from the papers printed by the image forming apparatus as other device in a short period of time by using the book binding apparatus 10 efficiently.

### Automatic Book Binding

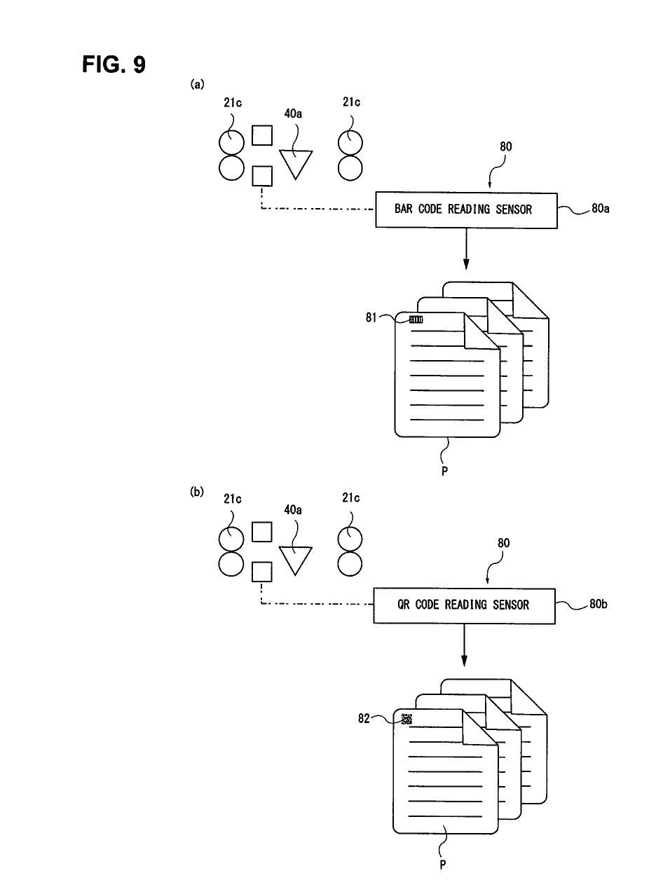

The paper feeding apparatus 20 is provided with a book binding information reading unit 80 which reads the book binding information adhered to the recorded paper. The bookbinding information acquired by the book binding information reading unit 80 is transmitted to the book binding apparatus 10, and the recorded paper is fed from the paper feeding apparatus 20 to the bookbinding apparatus 10 one sheet by one sheet, and the papers are bundled and bound into the paper bundle by the book binding apparatus 10. As shown in FIG. 9(a), the book binding information reading unit 80 is provided with, for example, a bar code reading sensor 80a. The bar code reading sensor 80a reads a bar code 81 on a printed surface of the paper P. The book binding information is recorded in the bar code 81, and the book binding information acquired by the bar code reading sensor 80a is sent to the paper feeding apparatus side book binding information setting part 23 and transmitted to the communication part 14 of the bookbinding apparatus 10 via the communication part 24, and thereby a book binding operation can be operated automatically. Namely, the number of the binding booklets and the number of the papers to be bundled in the book binding are recorded in the bar code 81, and the paper on which the bar code 81 is recorded and the following paper are fed to the book binding apparatus 10 one sheet by one sheet, and in the book binding apparatus 10, a predetermined number of the booklets is bound based on the book binding information acquired from the bar code 81.

Further, for example, a QR code (registered trademark) 82 as shown in FIG. 9(b) may be used instead of the bar code 81. In such a case, the bookbinding information reading unit 80 should be formed as a corresponding reader. For example, in a case in which the QR code (registered trademark) 82 is used instead of the bar code 81, it is necessary to use a QR code reading sensor 80b which has a camera function capable of reading the QR code (registered trademark) instead of the bar code reading sensor 80a.

### Print Checking Function

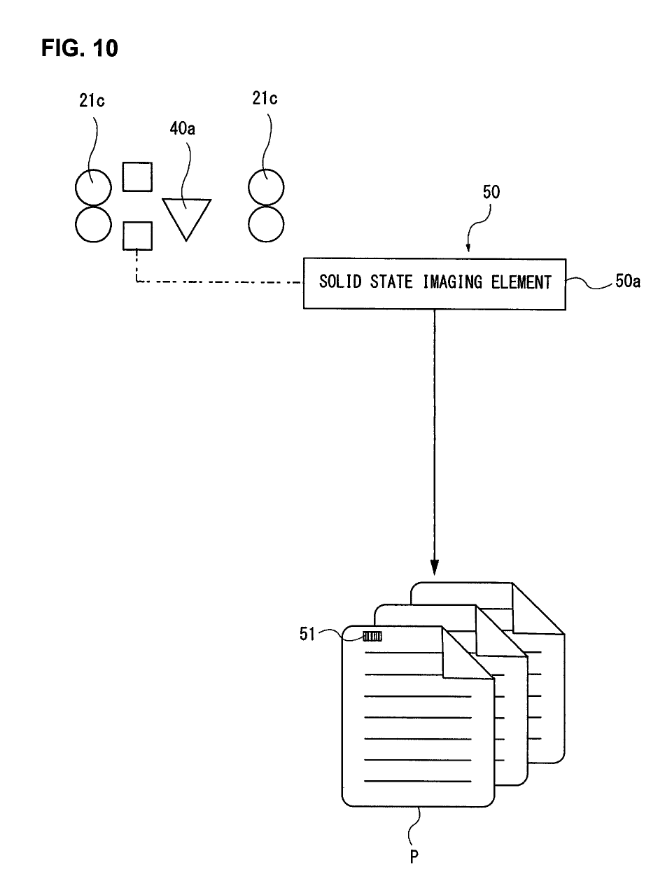

The paper feeding apparatus 20 is provided with a recording state recognizing unit 50 which recognizes a recording state of the recorded paper. As shown in FIG. 10, the recording state recognizing unit 50 is provided with, for example, a solid state imaging element 50a, and the solid state imaging element 50a executes various kinds of checks on a printed surface of the paper. In a case in which the recording state recognized by the recording state recognizing unit 50 is defective, for example, in a case in which a defectiveness such as “disarrangement of pages”, “NG of printing deviation or blur” or the like is detected, detection information is sent to the feeding control part 22 and then the feeding control part 22 controls the feeding part 21 to stop the feeding by the paper feeding apparatus 20 and to send the information to the communication part 14 of the book binding apparatus 10 via the communication part 24, and then the bookbinding control part 12 controls the book binding part 11 to stop the book binding by the book binding apparatus 10. In this way, in a case in which the recording state recognized by the recording state recognizing unit 50 is defective, the feeding by the paper feeding apparatus 20 is stopped and the book binding by the book binding apparatus 10 is automatically stopped, and then the stopping of the system is warned by means of a buzzer or display.

### Paper Reversing Function

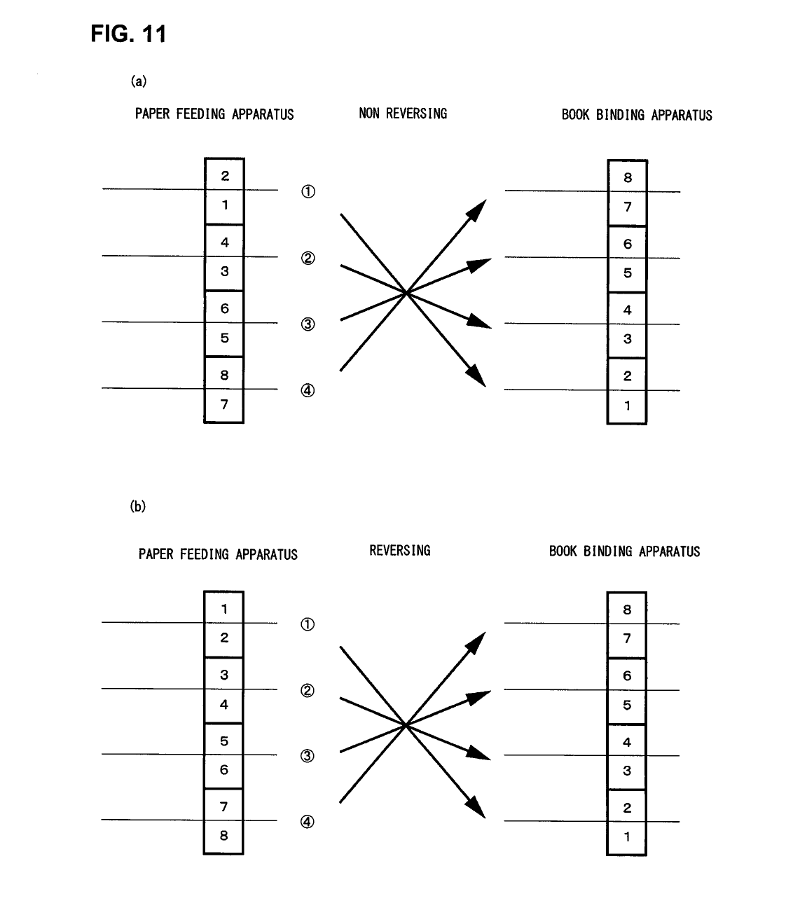

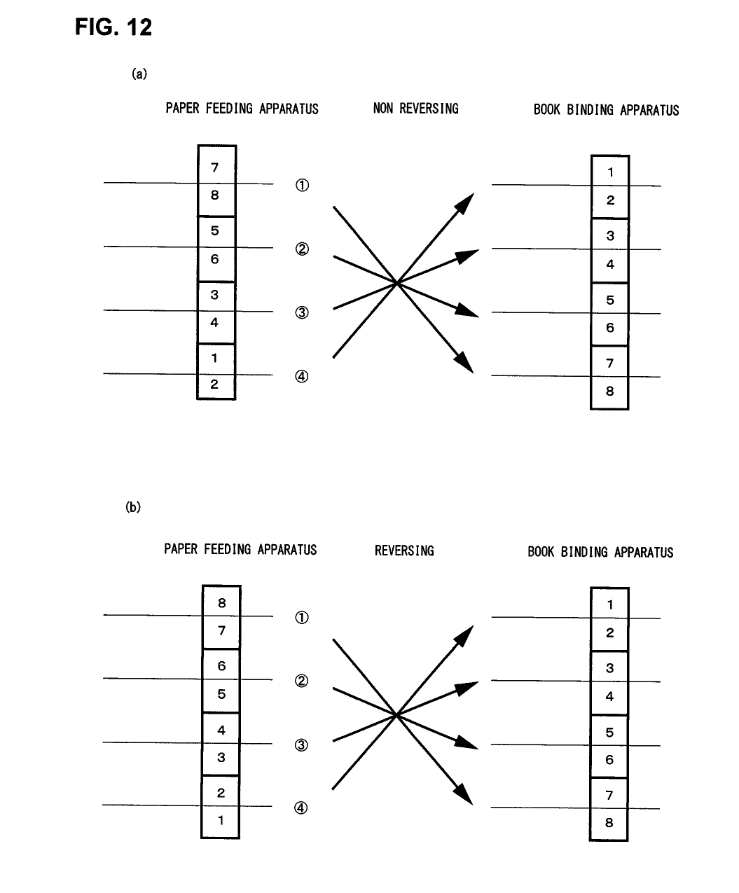

In the book binding apparatus 10 and the paper feeding apparatus 20, book binding page order selection buttons 13c, 23c are arranged, respectively. A book binding page order is set in the book binding apparatus side book binding information setting part 13 or the paper feeding apparatus side book binding information setting part 23 by either of operation of the book binding page order selection buttons 13c, 23c, and the paper reversing part 40 is controlled based on the set bookbinding information. As shown in FIGS. 11(a) and 11(b), and FIGS. 12(a) and 12(b), the book binding page order includes a type 1 in which a front page is arranged at a lower end and a type 2 in which the front page is arrange at an upper end.

FIGS. 11(a) and 11(b) illustrate the feeding according to the type 1 of the book binding page order. In the type 1, a first page to an eighth page are bound with the pages of 2 and 1, 4 and 3, 6 and 5, 8 and 7 laminated in this order from the lower end. In a case in which the page order of the papers loaded in the paper feeding apparatus 20 corresponds to the order of the pages of 8 and 7, 6 and 5, 4 and 3, 2 and 1 from the lower end toward the upper end, the paper to be fed from the paper feeding apparatus 20 is fed to the book binding apparatus 10 one sheet by one sheet without reversing the paper, and the papers are bound into the paper bundle by the book binding apparatus 10 (FIG. 11(a)). Further, for example, in a case in which the page order of the papers loaded in the paper feeding apparatus 20 corresponds to the order of the pages of 7 and 8, 5 and 6, 3 and 4, 1 and 2 from the lower end toward the upper end, the feeding control part 22 controls the paper reversing part 40 based on the page information relating to a front surface and a rear surface of a paper acquired by a CCD sensor which forms the page reading unit 60 so as to feed the papers to the book binding apparatus 10 one sheet by one sheet after reversing the papers, and the papers are bound into the paper bundle by the book binding apparatus 10 (FIG. 11(b)).

FIGS. 12(a) and 12(b) illustrate the feeding according to the type 2 of the book binding page order. In the type 2, the first page to the eighth page are bound from the upper end with the pages of 7 and 8, 5 and 6, 3 and 4, 1 and 2 laminated in this order from the lower end. In the type 2, in a case in which the page order of the papers loaded in the paper feeding apparatus 20 corresponds to the order of pages of 1 and 2, 3 and 4, 5 and 6, 7 and 8 from the lower end toward the upper end, the paper to be fed from the paper feeding apparatus 20 is fed to the book binding apparatus 10 one sheet by one sheet without reversing the paper, and the papers are bound into the paper bundle by the book binding apparatus 10 (FIG. 12 (a)). Further, for example, in a case in which the page order of the papers loaded in the paper feeding apparatus 20 corresponds to the order of the pages of 2 and 1, 4 and 3, 6 and 5, 8 and 7 from the lower end toward the upper end, the feeding control part 22 controls the paper reversing part 40 based on the page information relating to the front surface and the rear surface of the paper acquired by the CCD sensor so as to feed the papers to the book binding apparatus 10 one sheet by one sheet after reversing the papers, and the papers are bound into the paper bundle by the book binding apparatus 10 (FIG. 12 (b)).

### INDUSTRIAL APPLICABILITY

The present invention can be applied to a book binding system which binds and bundles a plurality of recorded papers into a booklet having a paper bundle, and a large amount of the booklets can be bound in a short period of time by using the book binding apparatus efficiently.

### REFERENCE SIGNS LIST

A, B: printing system as other device

G: booklet

K: cart tray

S1, S2: paper detection sensor

1: book binding system

10: book binding apparatus

11: book binding part

12: book binding control part

13: book binding apparatus side book binding information setting part

20: paper feeding apparatus

21: feeding part

22: feeding control part

23: paper feeding apparatus side book binding information setting part

30: paper feeding apparatus

32: feeding control part

33: paper feeding apparatus side book binding information setting part

40: paper reversing part

50: recording state recognizing unit

60: page reading unit

80: book binding information reading unit

92a, 92b: loading base

93: delivery part

93a1: upper side sucking part

93a2: upper side feeding path

93b1: lower side sucking part

93b2: lower side feeding path

93c: collection delivery part

93a11, 93b11: sucking fan

93a12, 93b12: delivery belt

93a13, 93b13: cover

100: control apparatus

FIG. 1

BOOK BINDING SYSTEM 1

FIG. 2

23 PAPER FEEDING APPARATUS SIDE BOOK BINDING INFORMATION SETTING PART

22 FEEDING CONTROL PART

13 BOOK BINDING APPARATUS SIDE BOOK BINDING INFORMATION SETTING PART

12 BOOK BINDING CONTROL PART

FIG. 3

33 PAPER FEEDING APPARATUS SIDE BOOK BINDING INFORMATION SETTING PART

32 FEEDING CONTROL PART

13 BOOK BINDING APPARATUS SIDE BOOK BINDING INFORMATION SETTING PART

12 BOOK BINDING CONTROL PART

FIG. 6(a)

100 CONTROL APPARATUS

FIG. 7

23 PAPER FEEDING APPARATUS SIDE BOOK BINDING INFORMATION SETTING PART

22 FEEDING CONTROL PART

13 BOOK BINDING APPARATUS SIDE BOOK BINDING INFORMATION SETTING PART

12 BOOK BINDING CONTROL PART

FIG. 8

BOOK BINDING SYSTEM 1

PAPER FEEDING APPARATUS 20

80 BOOK BINDING INFORMATION READING UNIT

23c BOOK BINDING PAGE ORDER SELECTION BUTTON

23a NUMBER OF BINDING BOOKLETS SETTING BUTTON

23b NUMBER OF PAPERS SETTING BUTTON

23 PAPER FEEDING APPARATUS BOOK BINDING INFORMATION SETTING PART

24 COMMUNICATION PART

40 PAPER REVERSING PART

22 FEEDING CONTROL PART

60 PAGE READING UNIT

21 FEEDING PART

50 RECORDING STATE RECOGNIZING UNIT

BOOK BINDING APPARATUS 10

13c BOOK BINDING PAGE ORDER SELECTION BUTTON

13a NUMBER OF BINDING BOOKLETS SETTING BUTTON

13b NUMBER OF PAPERS SETTING BUTTON

14 COMMUNICATION PART

13 BOOK BINDING APPARATUS SIDE BOOK BINDING INFORMATION SETTING PART

12 BOOK BINDING CONTROL PART

11 BOOK BINDING PART

FIG. 9(a)

80a BAR CODE READING SENSOR

FIG. 9(b)

80b QR CODE READING SENSOR

FIG. 10

50a SOLID STATE IMAGING ELEMENT

FIG. 11(a)

PAPER FEEDING APPARATUS

NON REVERSING

BOOK BINDING APPARATUS

FIG. 11(b)

PAPER FEEDING APPARATUS

REVERSING

BOOK BINDING APPARATUS

FIG. 12(a)

PAPER FEEDING APPARATUS

NON REVERSING

BOOK BINDING APPARATUS

FIG. 12(b)

PAPER FEEDING APPARATUS

REVERSING

BOOK BINDING APPARATUS

1. A book binding system comprising:
a book binding apparatus which bundles and binds a plurality of recorded papers into a booklet having a paper bundle; and
a paper feeding apparatus which feeds the recorded paper to the book binding apparatus one sheet by one sheet, wherein
the book binding apparatus includes a book binding part which binds the booklet, a book binding control part which controls the book binding part based on book binding information, and a book binding apparatus side book binding information setting part which sets the book binding information,
the paper feeding apparatus includes a feeding part which feeds the recorded paper one sheet by one sheet, a feeding control part which controls the feeding part based on the book binding information, and a paper feeding apparatus side book binding information setting part which sets the book binding information,
the book binding apparatus and the paper feeding apparatus are communicable with each other, and
based on the book binding information set in the book binding apparatus side book binding information setting part or the paper feeding apparatus side book binding information setting part, the recorded paper is fed from the paper feeding apparatus to the book binding apparatus one sheet by one sheet and the recorded papers are bundled and bound by the book binding apparatus.

2. The book binding system according to claim 1, wherein the book binding information includes the number of the binding booklets and the number of the papers bundled in book binding.

3. The book binding system according to claim 1, wherein the paper feeding apparatus includes a reading unit which reads the book binding information adhered to the recorded paper,
the book binding information acquired by the reading unit is transmitted to the book binding apparatus,
the recorded paper is fed from the paper feeding apparatus to the book binding apparatus one sheet by one sheet, and
the recorded papers are bound into the paper bundle by the book binding apparatus.

4. The book binding system according to claim 1, wherein the paper feeding apparatus includes a recording state recognizing unit which recognizes a recording state of the recorded paper, and
in a case in which the recording state recognized by the recording state recognizing unit is defective, the feeding by the paper feeding apparatus is stopped and the book binding by the book binding apparatus is stopped.

5. The book binding system according to claim 1, wherein the paper feeding apparatus includes a paper reversing part which reverses the paper to be fed between a front surface and a rear surface, and
the paper feeding apparatus controls the paper reversing part based on the book binding information and feeds the paper to be fed to the book binding apparatus one sheet by one sheet without reversing the paper so that the papers are bound into the paper bundle by the book binding apparatus, or feeds the paper to be fed to the book binding apparatus one sheet by one sheet after reversing the paper so that the papers are bound into the paper bundle by the book binding apparatus.

6. The book binding system according to claim 1, wherein the feeding part includes:
a loading base which loads the paper; and
a delivery part which feeds the paper loaded on the loading base to the book binding apparatus one sheet by one sheet.

7. The book binding system according to claim 6, wherein the delivery part includes a sucking fan which feeds the loaded paper while sucking one sheet by one sheet.
